(19) United States
(12) Patent Application Publication
(10) Pub. No.: US 2025/0337703 A1
(43) Pub. Date: Oct. 30, 2025

(54) MESSAGE SENDING

(71) Applicant: Beijing Zitiao Network Technology Co., Ltd., Haidian District (CN)

(72) Inventors: Jiahui Yang, Beijing (CN); Jiayi Xu, Beijing (CN)

(21) Appl. No.: 19/192,834

(22) Filed: Apr. 29, 2025

Related U.S. Application Data
(63) Continuation of application No. PCT/CN2024/089892, filed on Apr. 25, 2024.

(51) Int. Cl. H04L 51/04; H04L 51/10

(52) U.S. Cl. CPC H04L 51/04; H04L 51/10

(57) ABSTRACT

Provided in the disclosure a method for sending a message, an apparatus, a device and a storage medium. The method proposed comprises: in response to a viewing request, obtaining a target content from a server and playing the target content in a target interface; presenting a first input box in the target interface in response to a selection of a first control in the target interface; receiving first input information via the first input box; and generating a first message based on the first input information and sending the first message in a session with a target user, the target user being associated with the target content.

### CROSS-REFERENCE

This application claims priority to PCT patent application PCT/CN2024/089892, entitled “Method for Sending a Message, apparatus, device and storage medium” filed on Apr. 25, 2024, the entire content of which are incorporated herein by reference.

### FIELD

Example embodiments of the present disclosure generally relate to the computer field, and more particularly, to message sending.

### BACKGROUND

With the development of computer technology, the Internet has become an important platform for information interaction between people. In this fast-paced society, people expect to use a more convenient form of reply in the process of performing information interaction through the Internet.

### SUMMARY

In a first aspect of the present disclosure, a method for sending a message is provided. The method comprises: in response to a viewing request, obtaining a target content from a server and playing the target content in a target interface; presenting a first input box in the target interface in response to a selection of a first control in the target interface; receiving first input information via the first input box; and generating a first message based on the first input information and sending the first message in a session with a target user, the target user being associated with the target content.

In a second aspect of the present disclosure, an apparatus for sending a message is provided. The apparatus comprises: a playing module configured to, in response to a viewing request, obtain a target content from a server and play the target content in a target interface; a presenting module configured to present a first input box in the target interface in response to a selection of a first control in the target interface; a receiving module configured to receive first input information via the first input box; and a sending module configured to generate a first message based on the first input information and send the first message in a session with a target user, the target user being associated with the target content.

In a third aspect of the present disclosure, an electronic device is provided. The device comprises: at least one processing unit; and at least one memory, coupled to the at least one processing unit and storing instructions executed by the at least one processing unit. The instructions, when executed by the at least one processing unit, cause the device to perform the method according to the first aspect of the present disclosure.

In a fourth aspect of the present disclosure, a computer readable storage medium is provided. The computer readable storage medium stores a computer program thereon. The computer program may be executed by a processor to implement the method according to the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective embodiments of the present disclosure will become more apparent from the following detailed description with reference to the accompanying drawings. The same or similar reference numerals represent the same or similar elements throughout the figures, where:

FIG. 1 illustrates a schematic diagram of an example environment in which embodiments of the present disclosure may be implemented;

FIGS. 2A-2C illustrate example interfaces according to some embodiments of the present disclosure;

FIG. 3 illustrates a flowchart of an example process of sending a message according to some embodiments of the present disclosure;

FIG. 4 illustrates a schematic structural block diagram of an example apparatus for sending a message according to some embodiments of the present disclosure; and

FIG. 5 illustrates a block diagram of an electronic device capable of implementing various embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure may be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be noted that the headings of any sections/subsections provided herein are not limiting. Various embodiments are described throughout this specification, and any type of embodiment may be included under any section/subsection. Furthermore, embodiments described in any section/subsection may be combined in any manner with any other embodiments described in the same section/subsection and/or different sections/subsections.

As used herein, the term “comprise” and its variants are to be read as open terms that mean “include, but is not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be further included below. The terms “first”, “second” and the like may refer to different or identical objects. Other explicit and implicit definitions may also be included below.

The embodiments of the present disclosure may involve user data, the acquisition and/or use of data, etc. These aspects shall comply with corresponding laws and regulations and relevant provisions. In the embodiments of this disclosure, all the collection, acquisition, treatment, processing, forwarding and use of data are performed with the user's knowledge and confirmation. Accordingly, when implementing respective embodiments of the present disclosure, the user should be informed of the type, scope of use, and use scenario of the data or information involved in the present disclosure in an appropriate manner in accordance with relevant laws and regulations, and user authorization should be obtained. The specific notification and/or authorization methods may vary according to the actual situation and application scenarios, and the scope of the present disclosure is not limited in this regard.

In the solutions in this specification and embodiments, the processing of personal information, if involved, will be processed on the premise of legal basis (such as obtaining the consent of the personal information subject, or necessary to perform the contract, etc.), and will only be processed within the specified or agreed scope. The user's refusal to process personal information other than the necessary information required for basic functions will not affect the user's use of basic functions.

Some conventional solutions, for example, are capable of reposting a target content (e.g., media content), and commenting on the target content after reposting. It can be understood that, in the foregoing solutions, due to the limited interface of an electronic device, user operation is restricted, and when a user interacts with a target user, a new window needs to be opened, and a corresponding target content cannot be referenced. Thus, the user has to spend more operation costs and time costs to complete message sending.

Embodiments of the present disclosure provide a solution for message sending. According to the solution, in response to a viewing request, a target content is obtained from a server and is played in a target interface; in response to a selection of a first control in the target interface, a first input box is presented in the target interface; first input information is received via the first input box; and a first message is generated based on the first input information and is sent in a session with a target user, the target user being associated with the target content.

In this way, the embodiments of the present disclosure can provide a corresponding reply portal in a viewing interface of the target content, so as to generate a reply message in a corresponding session. Thus, the embodiments of the present disclosure can, for example, more effectively support message sending in an electronic device (e.g., a mobile terminal) with a limited display size, and reduce interaction costs for users. In addition, the embodiments of the present disclosure can increase the amount of information that can be referenced during message sending, improve the efficiency of message sending, and reduce the operation cost for users.

Various example implementations of the solution will be further described in detail below with reference to the accompanying drawings.

### Example Environment

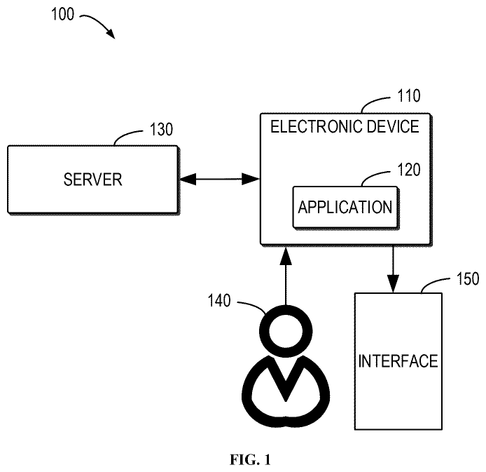

FIG. 1 shows a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include but are not limited to: video applications, social networking applications, or other appropriate applications. A user 140 may interact with the application 120 via the electronic device 110 and/or a device attached thereto.

In the environment 100 of FIG. 1, if the application 120 is active, the electronic device 110 may present an interface 150 for supporting interface interaction through the application 120.

In some embodiments, the electronic device 110 communicates with a server 130 to enable the provision of services to the application 120. The electronic device 110 may be any type of mobile terminal, fixed terminal or portable terminal, including mobile phone, desktop computer, laptop computer, notebook computer, netbook computer, tablet computer, media computer, multimedia tablet, palmtop computer, portable game terminal, VR/AR device, personal communication system (PCS) device, personal navigation device, personal digital assistant (PDA), audio/video player, digital camera/camcorder, positioning device, TV receiver, radio broadcast receiver, e-book device, gaming device, or any combination of the foregoing, including accessories and peripherals for these devices or any combination thereof. In some embodiments, the electronic device 110 may also support any type of interface for the target user (such as “wearable” circuitry, etc.).

The server 130 may be an independent physical server, or a server cluster or distributed system composed of multiple physical servers, or may further be a cloud server providing basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the application 120 which supports interface interaction in the electronic device 110.

A communication connection may be established between the server 130 and the electronic device 110. Communication connections may be established in a wired or wireless manner. Communication connections may include but are not limited to Bluetooth connections, mobile network connections, universal serial bus (USB) connections, Wireless Fidelity (WiFi) connections, etc. The embodiments of the present disclosure are not limited in this regard. In the embodiments of the present disclosure, the server 130 and the electronic device 110 may implement signaling interaction through the communication connection between them.

It should be understood that the structure and function of various elements in the environment 100 are described for illustrative purposes only and do not imply any limitation on the scope of the present disclosure.

Some example embodiments of the present disclosure will be described below with reference to the accompanying drawings.

### Example Interaction

An example process of message sending according to the embodiments of the present disclosure will be described below with reference to the accompanying drawings.

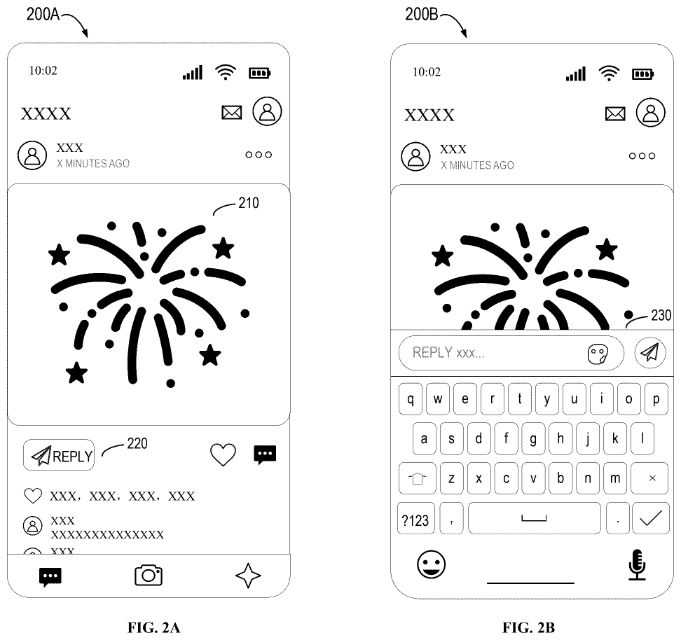

FIGS. 2A to 2C illustrate example interfaces 200A to 200C according to some embodiments of the present disclosure. The interfaces 200A to 200C may be provided, for example, by the electronic device 110 shown in FIG. 1.

FIG. 2A illustrates an example interface according to some embodiments of the present disclosure. In some embodiments, in response to receiving a viewing request from a user for a target content, the electronic device 110 may obtain, from a server, a target content and play the target content in a target interface.

As shown in FIG. 2A, based on the above operations, the user may view the target content 210 in the target interface 200A. In some embodiments, such target contents may include, but are not limited to, contents such as images, videos, etc. For ease of description, a video content is taken as an example for description. A target user who publishes the video content is referred to as a first user, and a user who watches the video content is referred to as a second user.

In some embodiments, the interface 200A may further comprise a first control 220. The second user may reply privately to the video content based on the first control 220 in the interface 200A. After receiving an operation that triggers the first control by the second user, the electronic device 110 may present an interface 200B as shown in FIG. 2B. In the interface, the second user may input first input information based on a first input box 230, so as to generate a first message (i.e., a private reply message) to reply to the first user privately. Such first input information includes, but is not limited to, a text content, an image content, an audio content, a video content, an emoji content.

In some embodiments, if a current user is the first user, the electronic device 110 may further present, in the target interface, a second control having a function different from that of the first control. The first user may share the video content based on the second control. For example, the first user may share the video content with friends, groups, or users that have been followed, and so on.

Additionally, when the second user triggers the first control, the electronic device 110 may further call a user list of private reply objects of the second user in the target interface. Such a user list may include, but is not limited to, the first user, friends, groups, or users that have been followed, etc. And, such a user list may be presented, for example, in the form of a floating window to maintain the browsing state of the video content. In addition, the electronic device 110 may further perform a marking operation on the first user, and such a marking operation may be, for example, sticking to the top, highlighting, or other operation that distinguishes the display from other users.

In some embodiments, the second user may further trigger a comment control in the target interface to comment on the video content. The electronic device 110 may present a second input box (e.g., a comment input box) in the target interface in response to a selection of a third control (e.g., a comment control) in the target interface by the second user. The second user inputs second input information (e.g., comment information) via the second input box to generate a comment content and present the same in a comment component of the video content.

In some embodiments, referring to FIG. 2B, when the second user makes a private reply to the video content, the electronic device 110 can maintain the browsing state of the video content. It can be understood that the second user may reply to the video content privately while watching the video content. Such private reply messages include, but are not limited to, text contents, image contents, audio contents, video contents, emoji contents, and attachments, etc. For ease of description, the text content is taken as an example for description.

In some embodiments, after the second user completes the private reply message, the electronic device 110 may present a reminder in the target interface that the private reply message has been successfully sent. Such a reminder may be, for example, in the target interface. The present disclosure is not intended to limit the reminder style for the successful sending of the private reply message.

In some embodiments, after the second user completes inputting the private reply message to the video content, a sending operation of the private reply message is triggered. Referring to FIG. 2C, the electronic device 110 may jump to a session interface 200C where, for example, the video content and the private reply message may be presented.

In some embodiments, both the video content and the private reply message may be displayed one by one, or prompt information may be presented, for example, in the form of a reference, to indicate that the reply message is a reply to the video content. The present disclosure is not intended to limit the form of the private reply message.

In some embodiments, prior to sending a private reply message 250 described above, the electronic device 110 may further send, in the session interface 200C, a second message 240 corresponding to the video content of the target content to indicate that the private reply message 250 is a reply to the target content.

In some embodiments, the video content may be presented in the form of non-interactive video content in the conference interface, that is, the video content may not contain a video link and does not present relevant information of the first user.

In other embodiments, the video content may be presented, in the session interface, in the form of a link to present the relevant information of the first user. When the user clicks the link, the link may be linked to a page of the video content corresponding to the first user.

Based on the interaction process discussed above, the embodiments of the present disclosure can provide a corresponding reply portal in the viewing interface of the target content to generate a reply message in a corresponding session. Thus, the embodiments of the present disclosure may support users to quickly generate reply messages about the target content in a session without the need to replicate the work, thereby reducing the consumption of local storage of the electronic device.

On the other hand, the embodiments of the present disclosure can further create reply messages in a session while maintaining presentation of works, thereby helping users to more effectively input reply messages. Thus, the embodiments of the present disclosure can, for example, more effectively support message sending in an electronic device (for example, a mobile terminal) with a limited display size, thereby reducing interaction costs for users. In addition, the embodiments of the present disclosure can increase the amount of information that can be referenced during message sending, improve the efficiency of message transmission, and reduce the operation cost for users.

### Example Process

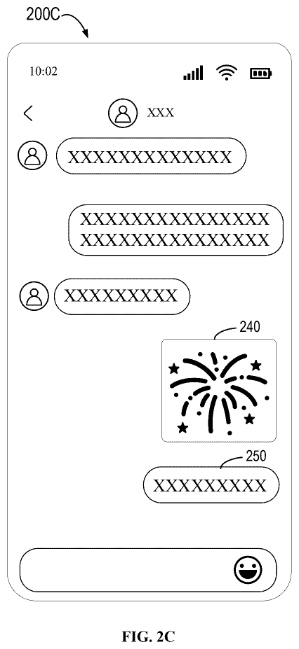

FIG. 3 illustrates a flowchart of an example process 300 of message sending according to some embodiments of the present disclosure. The process 300 may be implemented at the electronic device 110. The Process 300 is described below with reference to FIG. 1.

As depicted, at block 310, the electronic device 110, in response to a viewing request, obtains a target content from a server and plays the target content in a target interface.

At block 320, the electronic device 110 presents a first input box in the target interface in response to a selection of a first control in the target interface.

At block 330, the electronic device 110 receives first input information via the first input box.

At block 340, the electronic device 110 generates a first message based on the first input information and sends the first message in a session with a target user, the target user being associated with the target content.

In some embodiments, the process 300 further comprises: providing the first control at a target location of the target interface in response to a current user being different from the target user.

In some embodiments, the process 300 further comprises: in response to a current user being the target user, providing a second control different from the first control at a target location of the target interface, the second control for sharing the target content.

In some embodiments, the process 300 further comprises: presenting a second input box in the target interface in response to a selection of a third control in the target interface; receiving second input information via the second input box; and generating a comment content based on the second input information and presenting the comment content in a comment component of the target content.

In some embodiments, the first input information comprises at least one of: a text content, an image content, an audio content, a video content, and an emoji content.

In some embodiments, the process 300 further comprises: in response to completing the sending of the first message in the session with the target user, maintaining presentation of the target interface and presenting a reminder in the target interface that the first message has been sent.

In some embodiments, the process 300 further comprises: presenting a session interface in response to a viewing request for the session; and presenting the sent first message in the session interface.

In some embodiments, the process 300 further comprises: presenting prompt information in the session interface to indicate that the first message is a reply to the target content.

In some embodiments, the process 300 further comprises: generating a second message based on the target content; and before sending the first message, sending the second message in the session to indicate that the first message is a reply to the target content.

### Example Apparatus and Device

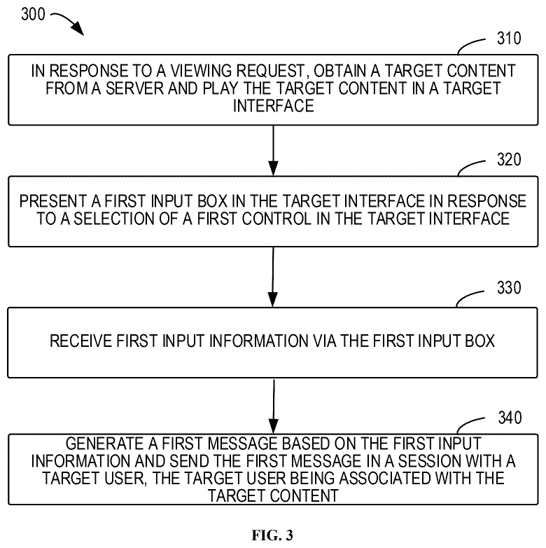

The embodiments of the present disclosure further provide a corresponding apparatus for implementing the above method or process. FIG. 4 illustrates a schematic structural block diagram of an exemplary apparatus 400 for message sending according to certain embodiments of the present disclosure. The apparatus 400 may be implemented as or included in the electronic device 110. Respective modules/components in the apparatus 400 may be implemented by hardware, software, firmware, or any combination thereof.

As shown in FIG. 400, the apparatus 400 comprises: a playing module 410 configured to, in response to a viewing request, obtain a target content from a server and play the target content in a target interface; a presenting module 420 configured to present a first input box in the target interface in response to a selection of a first control in the target interface; a receiving module 430 configured to receive first input information via the first input box; and a sending module 440 configured to generate a first message based on the first input information and send the first message in a session with a target user, the target user being associated with the target content.

In some embodiments, the apparatus 400 further comprises a first providing module configured to provide the first control at a target location of the target interface in response to a current user being different from the target user.

In some embodiments, the apparatus 400 further comprises a second providing module configured to, in response to a current user being the target user, provide a second control different from the first control at a target location of the target interface, the second control for sharing the target content.

In some embodiments, the apparatus 400 further comprises a first processing module configured to: present a second input box in the target interface in response to a selection of a third control in the target interface; receive second input information via the second input box; and generate a comment content based on the second input information and present the comment content in a comment component of the target content.

In some embodiments, the first input information comprises at least one of: a text content, an image content, an audio content, a video content, and an emoji content.

In some embodiments, the apparatus 400 further comprises a first presenting module configured to: in response to completing the sending of the first message in the session with the target user, maintain presentation of the target interface; and present a reminder in the target interface that the first message has been sent.

In some embodiments, the apparatus 400 further comprises a second presenting module configured to: present a session interface in response to a viewing request for the session; and present the sent first message in the session interface.

In some embodiments, the apparatus 400 further comprises a third presenting module configured to present prompt information in the session interface to indicate that the first message is a reply to the target content.

In some embodiments, the apparatus 400 further comprises a second processing module configured to: generate a second message based on the target content; and before sending the first message, send the second message in the session to indicate that the first message is a reply to the target content.

The modules included in the apparatus 400 may be implemented in various ways, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example, and not limitation, exemplary types of hardware logic components which may be used include field programmable gate arrays (FPGAs), application specific integrated circuits (ASICs), application specific standard products (ASSPs), systems on a chip (SOCs), complex programmable logic devices (CPLD), etc.

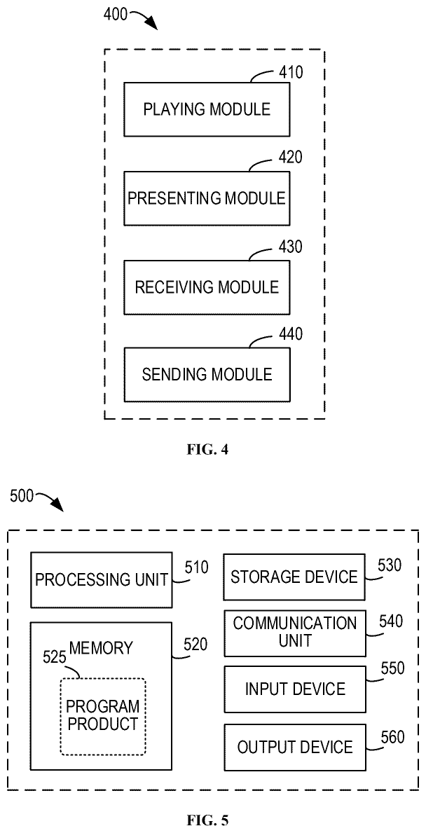

FIG. 5 shows a block diagram of an electronic device 500 that may implement one or more embodiments of the present disclosure. It should be understood that the electronic device 500 shown in FIG. 5 is merely exemplary and should not constitute any limitation on the functionality and scope of the embodiments described herein. The electronic device 500 shown in FIG. 5 may be used to implement the electronic device 110 in FIG. 1.

As shown in FIG. 5, the electronic device 500 is in the form of a general purpose computing device. Components of the electronic device 500 may include, but are not limited to, one or more processors or processing units 510, a memory 520, a storage device 530, one or more communication units 540, one or more input devices 1550, and one or more output devices 560. The processing unit 510 may be a physical or virtual processor and may execute various processing based on the programs stored in the memory 520. In a multi-processor system, a plurality of processing units executes computer-executable instructions in parallel to enhance parallel processing capability of the electronic device 500.

The electronic device 500 usually includes a plurality of computer storage mediums. Such mediums may be any attainable medium accessible by the electronic device 500, including but not limited to, a volatile and non-volatile medium, a removable and non-removable medium. The memory 520 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 530 may be a removable or non-removable medium, and may include a machine-readable medium (e.g., a memory, a flash drive, a magnetic disk) or any other medium, which may be used for storing information and/or data (e.g., training data for training) and be accessed within the electronic device 500.

The electronic device 500 may further include additional removable/non-removable, volatile/non-volatile storage mediums. Although not shown in FIG. 5, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 520 may include a computer program product 525 having one or more program modules, and these program modules are configured for performing various methods or acts of various embodiments of the present disclosure.

The communication unit 540 implements communication with another computing device via a communication medium. Additionally, functions of components of the electronic device 500 may be realized by a single computing cluster or a plurality of computing machines, and these computing machines may communicate through communication connections. Therefore, the electronic device 500 may operate in a networked environment using a logic connection to one or more other servers, a Personal Computer (PC) or a further general network node.

The input device 550 may be one or more various input devices, such as a mouse, a keyboard, a trackball, a voice-input device, and the like. The output device 560 may be one or more output devices, e.g., a display, a loudspeaker, a printer, and so on. The electronic device 500 may also communicate through the communication unit 540 with one or more external devices (not shown) as required, where the external device, e.g., a storage device, a display device, and so on, communicates with one or more devices that enable users to interact with the electronic device 500, or with any device (such as a network card, a modem, and the like) that enable the electronic device 500 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

What is claimed is:

1. A method for sending a message, comprising:
in response to a viewing request, obtaining a target content from a server, and playing the target content in a target interface;
presenting a first input box in the target interface in response to a selection of a first control in the target interface;
receiving first input information via the first input box; and
generating a first message based on the first input information and sending the first message in a session with a target user, the target user being associated with the target content.

2. The method of claim 1, further comprising:
providing the first control at a target location of the target interface in response to a current user being different from the target user.

3. The method of claim 2, further comprising:
in response to a current user being the target user, providing a second control different from the first control at a target location of the target interface, the second control for sharing the target content.

4. The method of claim 1, further comprising:
presenting a second input box in the target interface in response to a selection of a third control in the target interface;
receiving second input information via the second input box; and
generating a comment content based on the second input information and presenting the comment content in a comment component of the target content.

5. The method of claim 1, wherein the first input information comprises at least one of: a text content, an image content, an audio content, a video content, and an emoji content.

6. The method of claim 1, further comprising:
in response to completing the sending of the first message in the session with the target user, maintaining a presentation of the target interface and presenting a reminder in the target interface that the first message has been sent.

7. The method of claim 1, further comprising:
presenting a session interface in response to a viewing request for the session; and
presenting the sent first message in the session interface.

8. The method of claim 7, further comprising:
presenting prompt information in the session interface to indicate that the first message is a reply to the target content.

9. The method of claim 1, further comprising:
generating a second message based on the target content; and
before sending the first message, sending the second message in the session to indicate that the first message is a reply to the target content.

10. An electronic device, comprising:
at least one processing unit; and
at least one memory coupled to the at least one processing unit and storing instructions executable by the at least one processing unit, the instructions, when executed by the at least one processing unit, causing the electronic device to perform acts comprising:
in response to a viewing request, obtaining a target content from a server, and playing the target content in a target interface;
presenting a first input box in the target interface in response to a selection of a first control in the target interface;
receiving first input information via the first input box; and
generating a first message based on the first input information and sending the first message in a session with a target user, the target user being associated with the target content.

11. The electronic device of claim 10, the acts further comprising:
providing the first control at a target location of the target interface in response to a current user being different from the target user.

12. The electronic device of claim 11, the acts further comprising:
in response to a current user being the target user, providing a second control different from the first control at a target location of the target interface, the second control for sharing the target content.

13. The electronic device of claim 10, the acts further comprising:
presenting a second input box in the target interface in response to a selection of a third control in the target interface;
receiving second input information via the second input box; and
generating a comment content based on the second input information and presenting the comment content in a comment component of the target content.

14. The electronic device of claim 10, wherein the first input information comprises at least one of: a text content, an image content, an audio content, a video content, and an emoji content.

15. The electronic device of claim 10, the acts further comprising:
in response to completing the sending of the first message in the session with the target user, maintaining a presentation of the target interface and presenting a reminder in the target interface that the first message has been sent.

16. The electronic device of claim 10, the acts further comprising:
presenting a session interface in response to a viewing request for the session; and
presenting the sent first message in the session interface.

17. The electronic device of claim 16, the acts further comprising:
presenting prompt information in the session interface to indicate that the first message is a reply to the target content.

18. The electronic device of claim 10, the acts further comprising:
generating a second message based on the target content; and
before sending the first message, sending the second message in the session to indicate that the first message is a reply to the target content.

19. A non-transitory computer readable storage medium having a computer program stored thereon, wherein the computer program is executable by a processor to implement a method for sending a message, comprising:
in response to a viewing request, obtaining a target content from a server, and playing the target content in a target interface;
presenting a first input box in the target interface in response to a selection of a first control in the target interface;
receiving first input information via the first input box; and
generating a first message based on the first input information, and sending the first message in a session with a target user, the target user being associated with the target content.

20. The non-transitory computer readable storage medium of claim 19, the method further comprising:
providing the first control at a target location of the target interface in response to a current user being different from the target user.
